(19) United States
(12) Patent Application Publication
(10) Pub. No.: US 2022/0378046 A1
(43) Pub. Date: Dec. 1, 2022

(54) EFFECTS OF NF-kB SIGNALING INHIBITORS ON BED BUG RESISTANCE TO ORALLY PROVISIONED ENTOMOPATHOGENIC BACTERIA

(71) Applicant: South Dakota Board of Regents, Pierre, SD (US)

(72) Inventor: Jose Pietri, Sioux Falls, SD (US)

(21) Appl. No.: 17/708,829

(22) Filed: Mar. 30, 2022

Related U.S. Application Data
(60) Provisional application No. 63/169,567, filed on Apr. 1, 2021.

(51) Int. Cl. A01N 43/54; A01N 63/27; A01N 25/00; A01P 19/00; A01P 7/04

(52) U.S. Cl. CPC A01N 43/54; A01N 63/27; A01N 25/006; A01P 19/00; A01P 7/04

(57) ABSTRACT

Treatment compositions for controlling bed bugs and methods of use, including reducing bed bug resistance to a biological control agent are disclosed. The treatment compositions can include both a NF-kB signaling inhibitor and biological control agent, such as, an entomopathogenic bacteria, to improve the treatment composition efficacy against bed bugs. Provisioning of a small molecule inhibitor of NF-kB signaling can increase the rate of bed bug mortality during infection with a bacterial entomopathogen. Increased mortality can be independent of direct effects of the inhibitor on bacterial growth and can be instead the result of a reduced ability of bed bugs to clear the infection when treated with the inhibitor.

### CROSS-REFERENCE TO RELATED APPLICATIONS

This application claims priority and is related to U.S. Provisional Application Ser. No. 63/169,567 filed on Apr. 1, 2021 and entitled EFFECTS OF NF-kB SIGNALING INHIBITORS ON BED BUG RESISTANCE TO ORALLY PROVISIONED ENTOMOPATHOGENIC BACTERIA. The entire contents of this patent application are hereby expressly incorporated herein by reference including, without limitation, the specification, claims, and abstract, as well as any figures, tables, or drawings thereof.

### STATEMENT REGARDING FEDERALLY SPONSORED RESEARCH OR DEVELOPMENT

This invention was made with government support under Grant No. W911QY-19-1-0013, awarded by the Department of the Army, U.S. Army Contracting Command, Aberdeen Proving Ground, Natick Contracting Division, Ft Detrick Md. under Deployed Warfighter Protection (DWFP) Program. The government has certain rights in the invention.

### FIELD OF THE INVENTION

This disclosure relates to treatment compositions and methods, including prophylactic methods, of pest control, more particularly, using NF-kB signaling inhibitors to reduce bed bug resistance to orally provisioned entomopathogenic bacteria. The reduction of bed bug resistance to orally provisioned entomopathogenic bacteria improves the effectiveness of such microbial agents as biological control agents.

### BACKGROUND OF THE INVENTION

Bed bugs are prolific insect pests having a global impact, where there is an ongoing need for the development and improvement of bed bug control tools. Chemical control methods are failing at an increasing rate, creating a need for alternative methods. While the use of microbial agents for biological control of insects has had significant success against many pests and holds great promise, research in this area has only recently begun to be considered for bed bugs. Currently, the exploration of biological methods for bed bug control is limited.

Bed bugs, including the common bed bug, Cimex lectularius, are insect ectoparasites that live in close association with and feed on the blood of human hosts. Over the last several decades, they have experienced a substantial global resurgence, making them common insect pests in urban environments worldwide. Bed bugs are not only a nuisance, but their bites can also lead to a number of health problems, including anemia, anxiety, insomnia, allergic reactions, and secondary infections. Countless dollars are spent each year on treatment of infestations, yet there remains significant room for improvement and development of bed bug control tools. Most notably, there are growing concerns regarding the spread of resistance to common chemical insecticides across bed bug populations, and other effective non-chemical methods, such as whole-room heat treatments, can be tedious and expensive, limiting their broad application.

The use of microbial agents for biological control of insects is an alternative approach to chemical insecticides that has had significant success against agricultural pests and is being developed for use against medical and structural pests. A commercially available formulation under the name APREHEND® incorporates the entomopathogenic fungus Bauvaria bassiana for use in infecting bed bugs. However, with the exception of this product, no other efficacious biological control formulations for bed bugs have been developed. It is also known that because bed bugs mate by traumatic insemination, they can naturally become infected with pathogenic bacteria present in the environment during copulatory wounding, leading to post-mating mortality. This process could potentially also be exploited for biological control.

While the use of microbial agents for biological control of pests may have advantageous effects, bed bugs mount diverse immune responses to bacteria, both cellular and humoral. These include phagocytosis, lysozyme-mediated killing, and expression of antimicrobial peptides. If such responses occur following oral administration of biological control agents, such as entomopathogenic bacteria, then resistance to infection may be increased and the efficacy of the biological control agents may be reduced.

There is a need in the art for improved compositions and methods for enhancing the effectiveness of microbial agents to control bed bugs.

### BRIEF SUMMARY OF THE INVENTION

An advantage of the disclosure includes the chemical inhibition of pathways involved in bed bug immunity to boost mortality during infection with orally provisioned entomopathogenic bacteria by reducing the ability of bed bugs to clear bacterial infection. Reducing resistance to infection through inhibition of immune signaling provides a viable strategy for biological control of bed bugs. In an aspect, the disclosure includes the chemical inhibition of NF-kB signaling to reduce bed bug resistance to orally provisioned entomopathogenic bacteria, improving their effectiveness as biological control agents. It is an advantage of the present invention that the use of a NF-kB signaling inhibitor can synergistically improve the effectiveness of biological control agents, such as entomopathogenic bacteria, for pest control, including, but not limited to, the control of bed bugs.

In Example 1, a treatment composition for controlling bed bugs comprises an NF-kB signaling inhibitor; and a biological control agent comprising a gram-negative entomopathogenic bacteria, wherein the combination of the NF-kB signaling inhibitor and the biological control agent reduces bed bug resistance to the biological control agent.

Example 2 relates to the composition according to Example 1, wherein the entomopathogenic bacteria is selected from the group consisting of Xenorhabdus nematophila, Serratia entomophila, Serratia marcescens, Photorhabdus luminescens, Pseudomonas aeruginosa, Pseudomonas entomophila, Pseudomonas fluorescens, Rickettsiella popilliae, Rickettsiella chironomi, and Chromobacterium subtsugae.

Example 3 relates to the composition according to Example 1, wherein the concentration of entomopathogenic bacteria is present in an amount of between about 1×10³ CFU/mL to about 1×10¹⁰ CFU/mL.

Example 4 relates to the composition according to Example 1, wherein the NF-kB signaling inhibitor comprises an IKK inhibitor, a TAK1 inhibitor, an IKB degradation inhibitor, an NF-kB nuclear translocation inhibitor, a p65 acetylation inhibitor, an NF-kB-DNA binding inhibitor, an NF-kB transactivation inhibitor, or a combination thereof.

Example 5 relates to the composition according to Example 4, wherein the NF-kB signaling inhibitor comprises IKK16.

Example 6 relates to the composition according to Example 1, wherein the NF-kB signaling inhibitor comprises IKK16 and wherein the entomopathogenic bacteria comprises Pseudomonas entomophila.

Example 7 relates to the composition according to Example 1, wherein the NF-kB signaling inhibitor is present in a concentration of from about 1 μg/mL to about 50 μg/mL.

Example 8 relates to the composition according to Example 1, wherein the composition further comprises a carrier comprising water, dimethyl sulfoxide (DMSO), a ketone, an alcohol, an aldehyde, a polyethylene glycol, or a combination thereof, or wherein the composition further comprises a chemical insecticide or pesticide.

In Example 9, a method of reducing bed bug resistance to a biological control agent comprises combining an NF-kB signaling inhibitor with a biological control agent comprising a gram-negative entomopathogenic bacteria, reducing bed bug resistance to the biological control agent.

Example 10 relates to the method according to Example 9, wherein the bed bug mortality is higher with the combination of the NF-kB signaling inhibitor and the biological control agent compared to the bed bug mortality using the biological control agent alone.

Example 11 relates to the method according to Example 9, wherein the entomopathogenic bacteria is selected from the group consisting of Xenorhabdus nematophila, Serratia entomophila, Serratia marcescens, Photorhabdus luminescens, Pseudomonas aeruginosa, Pseudomonas entomophila, Pseudomonas fluorescens, Rickettsiella popilliae, Rickettsiella chironomi, and Chromobacterium subtsugae.

Example 12 relates to the method according to Example 9, wherein the concentration of entomopathogenic bacteria is present in an amount of between about 1×10³ CFU/mL to about 1×10¹⁰ CFU/mL.

Example 13 relates to the method according to Example 9, wherein the NF-kB signaling inhibitor comprises an IKK inhibitor, a TAK1 inhibitor, an IKB degradation inhibitor, an NF-kB nuclear translocation inhibitor, a p65 acetylation inhibitor, an NF-kB-DNA binding inhibitor, an NF-kB transactivation inhibitor, or a combination thereof.

Example 14 relates to the method according to Example 11, wherein the NF-kB signaling inhibitor comprises IKK16.

Example 15 relates to the method according to Example 9, wherein the NF-kB signaling inhibitor comprises IKK16 and wherein the entomopathogenic bacteria comprises Pseudomonas entomophila.

Example 16 relates to the method according to Example 9, wherein the NF-kB signaling inhibitor is present in a concentration of from about 1 μg/mL to about 50 μg/mL.

In Example 17, a method of controlling bed bugs comprises providing a therapeutically effective amount of a treatment composition comprising an NF-kB signaling inhibitor and a biological control agent comprising a gram-negative entomopathogenic bacteria, attracting the bed bugs to the treatment composition, and infecting the bed bugs with the treatment composition, wherein the combination of the NF-kB signaling inhibitor and the biological control agent reduces bed bug resistance to the biological control agent.

Example 18 relates to the method according to Example 17, wherein the treatment composition is provided as a bait or trap ingestible to the bed bugs.

Example 19 relates to the method according to Example 17, wherein the treatment composition is provided as an aerosol, a solution, a spray, or a gel, and applied to a substrate surface.

Example 20 relates to the method according to Example 19, wherein the substrate surface is a surface of a bed frame, headboard, door or window trim, light switch, baseboard, mattress, carpet, furniture, linen, dust ruffle, and/or bedding.

While multiple embodiments are disclosed, still other embodiments of the present invention will become apparent to those skilled in the art from the following detailed description, which shows and describes illustrative embodiments of the invention. Accordingly, the figures and detailed description are to be regarded as illustrative in nature and not restrictive.

### BRIEF DESCRIPTION OF THE FIGURES

FIG. 1 shows a diagram with an overview of the NF-kB signaling pathway in insects. The diagram identifies how the immune deficiency (IMD) and Toll pathways are two distinct signaling cascades with similar organization that are activated at the cell membrane (M) by sensing of Gram-negative and Gram-positive bacteria, respectively. Activation ultimately leads to the translocation of NF-kB transcription factors (e.g., Relish, Dif/Dorsal) to the cell nucleus (N). Nuclear translocation of NF-kB results in transcription of genes involved in immunity, such as antimicrobial peptides.

FIG. 2 shows a graph of the seven-day survivorship of bed bugs fed NF-kB signaling inhibitors. Inhibitors were dissolved in dimethyl sulfoxide (DMSO) and diluted in a blood meal to a final concentration of 5 μg/mL or 10 μg/mL. FIG. 2 shows the cumulative survival from two independent biological replicates of 10-15 adult insects per treatment group assessed at 7 days post-feeding.

FIG. 3A shows a graph of the direct effects of NF-kB signaling inhibitors on Pseudomonas entomophila. Inhibitors dissolved in DMSO were added to bacterial cultures at a final concentration of 10 μg/mL. Cultures were shaken overnight at room temperature and bacterial growth was quantified by measurement of optical density of each sample (OD₆₀₀) on a spectrophotometer. FIG. 3A shows the mean +/−SEM from 3 independent biological replicates. Differences in growth relative to the DMSO control (set at 1) were assessed by one sample t-test.

FIG. 3B shows a graph of the direct effects of NF-kB signaling inhibitors on Bacillus thuringiensis israelensis. Inhibitors dissolved in DMSO were added to bacterial cultures at a final concentration of 10 μg/mL. Cultures were shaken overnight at room temperature and bacterial growth was quantified by measurement of optical density of each sample (OD₆₀₀) on a spectrophotometer. FIG. 3A shows the mean +/−SEM from 3 independent biological replicates. Differences in growth relative to the DMSO control (set at 1) were assessed by one sample t-test.

FIG. 4A shows a graph of the three-day survivorship of bed bugs fed with a combination of NF-kB signaling inhibitors and B. thuringiensis israelensis. Shown is the cumulative survival from 3 independent biological replicates of 10-14 adult insects per group. All three replicates produced consistent patterns and no mortality was observed in blood controls.

FIG. 4B shows a graph of the three-day survivorship of bed bugs fed with a combination of NF-kB signaling inhibitors and P. entomophila. Shown is the cumulative survival from 3 independent biological replicates of 10-14 adult insects per group. All three replicates produced consistent patterns and no mortality was observed in blood controls.

FIG. 5 shows a graph of P. entomophila load during in vivo infection. Adult bed bugs were fed a blood meal containing P. entomophila with or without 10 μg/mL of IKK16 added. At 24 hours post-feeding, living and dead insects were surface sterilized, homogenized, and plated on LB agar to estimate the load of P. entomophila (expressed as CFU/insect). FIG. 5 shows individual data points derived from two independent biological replicates and their mean. Bacterial loads were compared using ANOVA with adjustment for multiple comparisons.

Various embodiments of the present invention will be described in detail with reference to the figures. Reference to various embodiments does not limit the scope of the invention. Figures represented herein are not limitations to the various embodiments according to the invention and are presented for exemplary illustration of the invention.

### DETAILED DESCRIPTION

The embodiments of this disclosure are not limited to particular treatment compositions and methods of application or use thereof for controlling and/or preventing bed bug populations, which can vary and are understood by skilled artisans. It is further to be understood that all terminology used herein is for the purpose of describing particular embodiments only, and is not intended to be limiting in any manner or scope. So that the various implementations herein may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

The term “about,” as used herein, refers to variation in the numerical quantity that can occur, for example, through typical measuring techniques and equipment, with respect to any quantifiable variable, including, but not limited to, mass, volume, time, distance, wave length, frequency, voltage, current, and electromagnetic field. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The methods and compositions of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods and compositions.

The term “harborage,” as used herein, refers to the locations of a bed bug infestation away from the food source (e.g. blood meal from a human most often in a bed). For example, bed bugs are known to utilize almost every crack or crevice in a home, including headboards, baseboards, dressers, walls, carpet and the like.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

While an understanding of the mechanism is not necessary to practice the present disclosure and while the present disclosure is not limited to any particular mechanism of action, it is contemplated that, in some embodiments, the use of entomopathogenic bacteria are well suited as treatments to control bed bug populations. In a further aspect, the use of an NF-kB signaling inhibitor in combination with entomopathogenic bacteria provide synergistic effects in reducing bed bug resistance to the entomopathogenic bacteria. Without being limited to any particular mechanism of action or theory, it is contemplated that the NF-kB signaling inhibitor boosts bed bug mortality by reducing the innate ability of bed bugs to clear the entomopathogenic bacteria (i.e. reduces resistance). The regulation of bed bug immunity is a viable strategy for biological control of bed bugs through reducing bed bug resistance to infection.

### Compositions

A deeper understanding of bacterial pathogenicity and anti-bacterial immunity in bed bugs is critical in order to most effectively leverage entomopathogenic bacteria to control bed bug infestation. Accordingly, alternative bed bug treatment options utilizing microbial agents for biological control are needed, including the reduction of bed bug resistance to biological control agents, such as orally provisioned entomopathogenic bacteria, to improve efficacy against bed bugs.

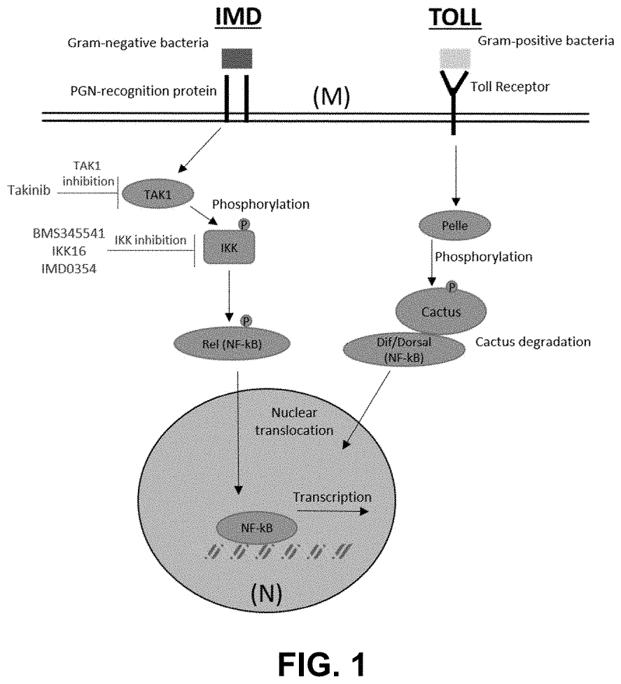

According to an aspect, a treatment composition for bed bug control is provided. As shown in FIG. 1, the Toll and immune deficiency (IMD) signaling pathways are the major regulators of humoral anti-bacterial immunity in insects. These pathways, which have been extensively characterized in model insects, transduce receptor-mediated recognition of pathogen-associated molecular patterns into the nuclear translocation of NF-kB transcription factors, ultimately inducing the expression of a multitude of effector genes (e.g., antimicrobial peptides). Bed bugs encode and express most components of the Toll and IMD pathways, including kinases IKK, TAK1, Pelle), NF-kB transcription factor homologs Relish, Dif/Dorsal) and antimicrobial peptides (i.e., Defensin).

In an aspect, chemical inhibition of NF-kB signaling using an IKK inhibitor, IMD0354, demonstrates suppressed expression of antimicrobial peptides and increased mortality during both bacterial and parasitic infections in Rhodnius prolixus, a related Hemipteran bug. In embodiments, similar effects of NF-kB inhibition can be seen in bed bugs for improving the efficacy of entomopathogens as biological control agents.

In an aspect, the treatment composition comprises an NF-kB signaling inhibitor. In certain embodiments, the NF-kB signaling inhibitor comprises an IKK inhibitor, TAK1 inhibitor, IKB degradation inhibitor, NF-kB nuclear translocation inhibitor, p65 acetylation inhibitor, NF-kB-DNA binding inhibitor, NF-kB transactivation inhibitor, or a combination thereof. In an aspect, NF-kB signaling inhibitors include, but are not limited to, BAY 11-7082, MG-115, MG-132, Lactacystin, Epoxomicin, Parthenolide, Carfilzomib, Pevonedistat (MLN-4924), JSH-23, Rolipram, Gallic acid, Anacardic acid, GYY 4137, p-XSC, CV 3988, Prostaglandin E2, LY 294002, Wortmannin, and Mesalamine. In a further aspect, TAK1 inhibitors include, but is not limited to, Takinib. In certain specific embodiments, the NF-kB signaling inhibitor comprises an IKK inhibitor. In an aspect, suitable IKK inhibitors include, but are not limited to, BMS345541, IKK16, IMD0354, TPCA 1, NF-kB Activation Inhibitor VI (BOT-64), Amlexanox, and SC-514 (GK 01140).

In an aspect, the compositions include from about 1 μg/mL to about 50 μg/mL, from about 1 μg/mL to about 45 μg/mL, from about 1 μg/mL to about 40 μg/mL, from about 1 μg/mL to about 35 μg/mL, from about 1 μg/mL to about 30 μg/mL, from about 1 μg/mL to about 25 μg/mL, from about 1 μg/mL to about 20 μg/mL, from about 1 μg/mL to about 15 μg/mL, from about 3 μg/mL to about 12 μg/mL, or from about 5 μg/mL to about 10 μg/mL of NF-kB signaling inhibitor. In alternative embodiments, the compositions include at least 1 μg/mL, at least 2 μg/mL, at least 3 μg/mL, at least 4 μg/mL, or at least 5 μg/mL of NF-kB signaling inhibitor. In addition, without being limited according to the invention, all ranges recited are inclusive of the numbers defining the range and include each integer within the defined range.

In a further aspect, biological control agents are included in the treatment compositions for having activity against bed bugs when administered orally. In an embodiment, the biological control agent comprises an entomopathogenic bacteria having activity against the common bed bug when administered orally. Entomopathogenic bacteria may include gram positive bacteria, gram negative bacteria, or small bacteria with no rigid cell wall. Examples of gram-positive bacteria include, but are not limited to, Bacillus, Lysinibacillus, Paenibacillus, Brevibacillus, Melissococcus, Enterococcus, Streptococcus, and Clostridium. In an embodiment, gram positive bacteria include, but are not limited to, Bacillus thuringiensis, Lysinibacillus sphaericus, Paenibacillus popilliae, Paenibacillus larvae, Brevibacillus laterosporus, Brevibacillus brevis, Melissococcus pluton, Enterococcus faecalis, Streptococcus pernyi, and Clostridium brevifaciens. Examples of gram-negative bacteria include, but are not limited to, Xenorhabdus, Serratia, Photorhabdus, Pseudomonas, Rickettsiella, and Chromobacterium. In an embodiment, gram-negative bacteria include, but are not limited to, Xenorhabdus nematophila, Serratia entomophila, Serratia marcescens, Photorhabdus luminescens, Pseudomonas aeruginosa, Pseudomonas entomophila, Pseudomonas fluorescens, Rickettsiella popilliae, Rickettsiella chironomi, and Chromobacterium subtsugae. Examples of bacteria with no rigid cell wall include, but are not limited to, Spiroplasma, such as, Spiroplasma melliferum. In certain specific implementations, the entomopathogenic bacteria is a gram-negative bacterium. In a further embodiment, the gram-negative bacterium is a Pseudomonas. In an aspect, the gram-negative bacterium comprises Pseudomonas entomophila. Additional entomopathogenic bacteria known to have entomopathogenic effects are further considered.

In an aspect, the compositions include from about 1×10³ CFU/mL to about 1×1 0¹⁰ CFU/mL, from about 1×10⁵ CFU/mL to about 1×10¹⁰ CFU/mL, or from about 1×10⁶ CFU/mL to about 1×10⁹ CFU/mL of the entomopathogenic bacteria. In addition, without being limited according to the invention, all ranges recited are inclusive of the numbers defining the range and include each integer within the defined range.

In various alternative embodiments, optional additional ingredients can also be added to the composition containing the NF-kB signaling inhibitor and the biological control agent. Such ingredients can be chosen to impart certain properties or characteristics of the composition, including, for example, improvement in physical properties or the addition of an aesthetic property such as color, or the reduction of thermal, UV or oxidative degradation, or the decrease of weight, or the increase of thermal insulation, thermal conductivity, or the addition or enhancement of various other functionalities and multi-functionalities. In a further embodiment, the composition further comprises a chemical insecticide or pesticide, a flavoring, a preserving agent, a dye, or a bitter agent.

In some embodiments, the composition further comprises a carrier or diluent. In an aspect, the carrier or diluent comprises water, dimethyl sulfoxide (DMSO), a ketone, an alcohol, an aldehyde, a polyethylene glycol, or a combination thereof. In some examples, the carrier or diluent comprises an alcohol selected from among an aromatic alcohol, a C1-C6 monohydric alcohol, C2-C6 polyhydric alcohol, a polyvalent alcohol, and combinations thereof. In some examples, the carrier or diluent comprises a ketone selected from among acetone, methyl ketone, methyl benzyl ketone, methyl ethyl ketone, methyl isopropyl ketone, methyl butyl ketone, ethyl ketone, benzyl methyl ketone, and combinations thereof.

### Methods of Use

In an aspect, the disclosure further provides for methods of reducing bed bug resistance to a biological control agent, and methods of controlling bed bugs. The bacterial load upon death (BLUM) is an intrinsic property of bacterial pathogens. Different pathogens consistently kill their hosts once a threshold bacterial load is reached. In general, the survival of an organism during a pathogenic infection can be altered in one of two ways. The organism can eliminate the pathogen, reducing its load, which is known as resistance, or it can modulate aspects of its own physiology to reduce damage from the infection without reducing pathogen load, which is known as tolerance. In an aspect, inhibition of NK-kB mediated immune responses is a mechanism that reduces resistance, since the effectors regulated by this pathway directly eliminate microbes.

In certain embodiments, the methods incorporating the use of an NF-kB signaling inhibitor are suitable for reducing bed bug resistance to a biological control agent. The method comprises combining an NF-kB signaling inhibitor with a biological control agent, and reducing bed bug resistance to the biological control agent. In embodiments, the biological control agent comprises an entomopathogenic bacteria. In an aspect, the entomopathogenic bacteria is a gram-negative bacterium. In a further embodiment, the bed bug mortality is higher with the combination of the NF-kB signaling inhibitor and the biological control agent compared to the bed bug mortality using the biological control agent alone.

In a further embodiment, a method of controlling bed bugs is disclosed. In an aspect, the methods comprise providing a therapeutically effective amount of a treatment composition comprising an NF-kB signaling inhibitor and a biological control agent comprising an entomopathogenic bacteria, attracting the bed bugs to the treatment composition, and infecting the bed bugs with the treatment composition. In an aspect, the combination of the NF-kB signaling inhibitor and the biological control agent reduces bed bug resistance to the biological control agent. In some embodiments, the entomopathogenic bacteria is a gram-negative bacterium.

As referred to herein, the NF-kB signaling inhibitor comprises an IKK inhibitor, TAK1 inhibitor, IKB degradation inhibitor, NF-kB nuclear translocation inhibitor, p65 acetylation inhibitor, NF-kB-DNA binding inhibitor, NF-kB transactivation inhibitor, or a combination thereof. In certain specific embodiments, the NF-kB signaling inhibitor comprises an IKK inhibitor. In an aspect, suitable IKK inhibitors include, but are not limited to, BMS345541, IKK16, IMD0354, TPCA 1, NF-kB Activation Inhibitor VI (BOT-64), Amlexanox, and SC-514 (GK 01140). In some specific implementations, the NF-kB signaling inhibitor comprises IKK16.

In an aspect, the entomopathogenic bacteria is present in an amount of from about 1×10³ CFU/mL to about 1×10¹⁰ CFU/mL, from about 1×10⁵ CFU/mL to about 1×10¹⁰ CFU/mL, or from about 1×10⁶ CFU/mL to about 1×10⁹ CFU/mL. In addition, without being limited according to the invention, all ranges recited are inclusive of the numbers defining the range and include each integer within the defined range.

As referred to herein, the entomopathogenic bacteria may include gram positive bacteria, gram negative bacteria, or small bacteria with no rigid cell wall. Examples of gram-positive bacteria include, but are not limited to, Bacillus, Lysinibacillus, Paenibacillus, Brevibacillus, Melissococcus, Enterococcus, Streptococcus, and Clostridium. In an embodiment, gram positive bacteria include, but are not limited to, Bacillus thuringiensis, Lysinibacillus sphaericus, Paenibacillus popilliae, Paenibacillus larvae, Brevibacillus laterosporus, Brevibacillus brevis, Melissococcus pluton, Enterococcus faecalis, Streptococcus pernyi, and Clostridium brevifaciens. Examples of gram-negative bacteria include, but are not limited to, Xenorhabdus, Serratia, Photorhabdus, Pseudomonas, Rickettsiella, and Chromobacterium. In an embodiment, gram-negative bacteria include, but are not limited to, Xenorhabdus nematophila, Serratia entomophila, Serratia marcescens, Photorhabdus luminescens, Pseudomonas aeruginosa, Pseudomonas entomophila, Pseudomonas fluorescens, Rickettsiella popilliae, Rickettsiella chironomi, and Chromobacterium subtsugae. Examples of bacteria with no rigid cell wall include, but are not limited to, Spiroplasma, such as, Spiroplasma melliferum. In certain specific embodiments, the entomopathogenic bacteria is a gram-negative bacterium. In a further embodiment, the gram-negative bacterium is a Pseudomonas. In an aspect, the gram-negative bacterium comprises Pseudomonas entomophila. Additional entomopathogenic bacteria known to have entomopathogenic effects are further considered.

In an aspect, the NF-kB signaling inhibitor is present in an amount of from about 1 μg/mL to about 50 μg/mL, from about 1 μg/mL to about 45 μg/mL, from about 1 μg/mL to about 40 μg/mL, from about 1 μg/mL to about 35 μg/mL, from about 1 μg/mL to about 30 μg/mL, from about 1 μg/mL to about 25 μg/mL, from about 1 μg/mL to about 20 μg/mL, from about 1 μg/mL to about 15 μg/mL, from about 3 μg/mL to about 12 μg/mL, or from about 5 μg/mL to about 10 μg/mL. In alternative embodiments, the methods include at least 1 μg/mL, at least 2 μg/mL, at least 3 μg/mL, at least 4 μg/mL, or at least 5 μg/mL of NF-kB signaling inhibitor. In addition, without being limited according to the invention, all ranges recited are inclusive of the numbers defining the range and include each integer within the defined range.

The disclosure further provides for methods of controlling the population of bed bugs and/or for preventing incursion of a population of bed bugs (i.e., prophylaxis, such as treatment of a room (e.g. hotels, homes) and/or articles commonly contacted by bed bugs (e.g. luggage as a traveler protection system)). In an aspect, the method comprises providing a therapeutically effective amount of a treatment composition comprising an NF-kB signaling inhibitor and a biological control agent, attracting bed bugs to the treatment composition, and infecting the bed bugs with the treatment composition. In an aspect, the biological control agent comprises entomopathogenic bacteria. In a further aspect, the entomopathogenic bacteria comprises a gram-negative bacterium. In an aspect, the combination of the NF-kB signaling inhibitor and the biological control agent reduces bed bug resistance to the biological control agent.

As referred to herein, the bed bugs are understood to include the family Cimicidae, which includes the human bed bugs Cimex lectularius, Cimex adjunctus and Cimex hemipterus. The methods and compositions of the disclosure are effective regardless of bed bug sex (i.e., mixed populations), feeding status and/or strain. In addition, all stages of bed bugs, from nymph to adults, are considered according to the methods and compositions of the disclosure.

According to embodiments, the treatment composition is provided as an aerosol, a solution, a spray, or a gel. In some examples, the treatment composition is applied to a treatment surface, such as by spraying the treatment composition onto a treatment surface. In a further embodiment, the treatment composition is provided in the form of a bait or trap ingestible to bed bugs. In an aspect, the bait or trap exposes the bed bug to the treatment composition, resulting in the ingestion of the treatment composition by the bed bug.

According to embodiments where the composition is deployed by spraying or applying topically to a treatment surface. The treatment substrate surfaces may include surfaces commonly found in bedrooms, hotels, and the like. These include, for example, bed frames, headboards, door and window trim, light switches, baseboards, mattresses, carpet, furniture pieces including for example tables, chairs, dressers and drawers, and the like (which may often include the secondary locations or harborages of bed bug populations), linens, dust ruffles, other bedding and the like. As one of skill in the art will readily ascertain, the treatment compositions can include any of the surfaces of these articles, including, for example, cracks and crevices of the same wherein bed bugs are expected to traverse. These surfaces can vary in the nature of the substrate, including for example fabrics, wood, laminate, and the like.

In one aspect, a preferred surface for the treatment composition is a fabric. Preferably, the fabric is cotton, such as jersey cotton. In an embodiment, the treatment substrate may further include an article of clothing of a human. Additional surfaces suitable for potential harborages for bed bugs may be suitable for the treatment compositions, which may be ascertained by those of ordinary skill in the art and are included in the scope of the present disclosure. Additional exemplary surfaces include, but are not limited to, carpet, cotton towels, polyester microfiber, tape or any manufactured textile.

In a further aspect, the methods provide for prophylactic treatment. In embodiments, the treatment surface is employed for covering or otherwise surrounding a point of contact for bed bugs. In an aspect, the treatment composition is employed as a prophylactic covering for a suitcase or other object which is often a carrier for bed bug populations from an infested location to another.

All publications and patent applications in this specification are indicative of the level of ordinary skill in the art to which this invention pertains. All publications and patent applications are herein incorporated by reference to the same extent as if each individual publication or patent application was specifically and individually indicated as incorporated by reference.

### EXAMPLES

Embodiments are further defined in the following non-limiting Examples. It should be understood that these Examples, while indicating certain embodiments of the disclosure, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

For the following non-limiting Examples, the Cincinnati SRL strain of Cimex lectularius was used for the population of bed bugs. This strain was derived from a population of individuals collected by technicians from Sierra Research Laboratories, Inc. (Modesto, Calif.) in 2007 and has been maintained under laboratory conditions since this time. Colonies were maintained at the University of South Dakota in plastic jars containing corrugated cardboard harborages at 28 +/−1° C. and 60-70% relative humidity on a 12:12 photoperiod. The colonies were fed aseptically collected defibrinated rabbit blood (Hemostat Laboratories, Dixon, Calif.) once per week using an artificial membrane system (Hemotek Ltd., Blackburn, United Kingdom).

The bed bugs were fed four individual small molecule inhibitors of NF-kB signaling (BMS345541, IKK16, IMD0354, Takinib) alone or in combination with two different bacterial entomopathogens (Pseudomonas entomophila and Bacillus thuringiensis israelensis). All chemical inhibitors were purchased from Sigma Aldrich (St. Louis, Mo.). Working stocks of 5 mg/mL were made in dimethyl sulfoxide (DMSO) for all inhibitors except for Takinib, which was dissolved at 2 mg/mL due to its lower solubility. The effects on both bed bug mortality and bacterial growth were assessed.

The IKK inhibitor BMS345541 may also be known as N1-(1,8-dimethylimidazo[1,2-a]quinoxalin-4-yl)ethane-1,2-diamine, and having the chemical structure (I) below:

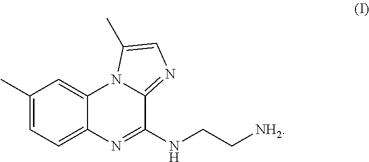 [SMILES: Cc1ccc2nc(NCCN)c3ncc(C)n3c2c1]

The IKK inhibitor IKK16 may also be known as IKK Inhibitor VII or (4-((4-(Benzo[b]thiophen-2-yl)pyrimidin-2-yl)amino)phenyl)(4-(pyrrolidin-1-yl)piperidin-1-yl)methanone, and having the chemical structure (II) below:

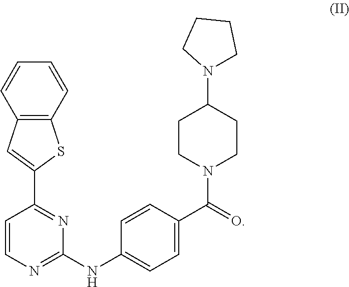 [SMILES: O=C(c1ccc(Nc2nccc(-c3cc4ccccc4s3)n2)cc1)N1CCC(N2CCCC2)CC1]

The IKK inhibitor IMD0354 may also be known as IKK-2 Inhibitor V or N-(3,5-bis(trifluoromethyl)phenyl)-5-chloro-2-hydroxybenzamide, and having the chemical structure (III) below:

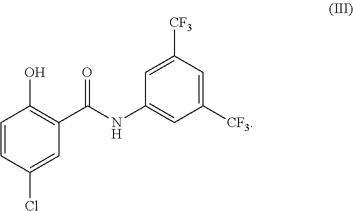 [SMILES: O=C(Nc1cc(C(F)(F)F)cc(C(F)(F)F)c1)c1cc(Cl)ccc1O]

The TAK1 inhibitor Takinib may also be known as 3-N-(1-propylbenzimidazol-2-yl)benzene-1,3-dicarboxamide, and having the chemical structure (IV) below:

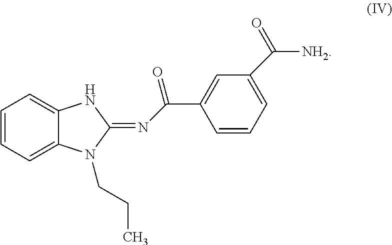 [SMILES: CCCn1/c(=N/C(=O)c2cccc(C(N)=O)c2)[nH]c2ccccc21]

### EXAMPLE 1

### Toxicity of NF-kB Signaling Inhibitors as Lone Agents

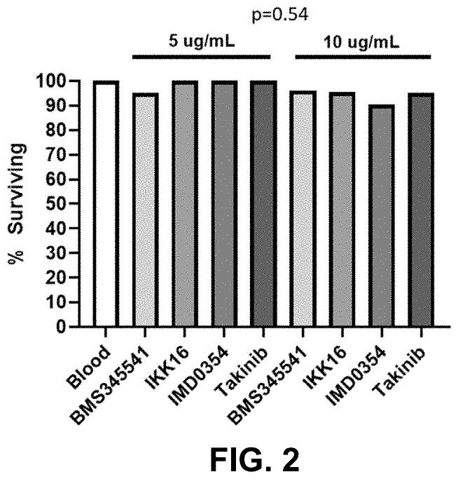

The toxicity of NF-kB signaling inhibitors was analyzed by feeding the inhibitors as lone agents to bed bugs. In particular, the four individual small molecule inhibitors of NF-kB signaling (BMS345541, IKK16, IMD0354, Takinib) were analyzed. The concentrations of inhibitors were further diluted to 5 μg/mL and 10 μg/mL in defibrinated rabbit blood for feeding to bed bugs to examine their effects as lone agents. A separate group of bed bugs were fed equivalent volumes of DMSO diluent in blood to serve as controls. Groups of bed bugs consisting of roughly even numbers of adult male and female bed bugs that had not blood fed for at least seven days were provided access to blood treated with each of the four inhibitors using the artificial membrane system (Hemotek Ltd.) until fully engorged. Mortality was then monitored regularly over a period of seven days. Two independent biological replicates consisting of 10-15 insects per group were carried out and cumulative survival at the end of the seven-day period was compared using chi-square testing. The results of the seven-day survivorship of bed bugs fed NF-kB signaling inhibitors are shown in FIG. 2.

As shown in FIG. 2, none of the NF-kB signaling inhibitors tested (BMS345541, IKK16, IMD0354, Takinib), whether provisioned at 5 μg/mL or 10 μg/mL, elicited significant mortality relative to DMSO controls (FIG. 2, chi-square test, p=0.54). Differences between treatment groups were not statistically significant as determined by chi-square testing. In fact, survival at 7 days post-feeding remained above 90% in all control groups and in all groups treated with inhibitors. As such, only two independent replicates of these experiments were performed due to a lack of observed effect that was consistent in both replicates. These results indicate that NF-kB inhibitors are not directly toxic to bed bugs at the doses given.

### EXAMPLE 2

### Effects of NF-kB Signaling Inhibitors on Growth of Bacterial Entomopathogen Cultures

The effects of NF-kB signaling inhibitors were further assessed on growth of bacterial entomopathogen cultures. Two bacterial entomopathogens were used in the present example. The Gram-positive bacterium B. thuringiensis israelensis was obtained from Carolina Biological Supply (Burlington, N.C., USA). This bacterium was investigated due to its potential activity against bed bugs when ingested. The Gram-negative bacterium P. entomophila was obtained from the German Collection of Microorganisms and Cell Cultures (DSMZ, Braunschweig, Germany). Stocks of these bacteria were grown overnight in Luria-Bertani (LB) medium on a shaker at room temperature.

To determine if the inhibitors had any direct impact on the growth of entomopathogenic bacteria prior to their administration in vivo, cultures of each bacterium were inoculated into LB medium and individual inhibitors were added to the cultures at a final concentration of 10 μg/mL. Cultures containing equal volumes of DMSO diluent served as controls. After shaking overnight at room temperature, growth of bacteria in the presence of inhibitors was quantified by measuring optical density of the cultures at 600 nm (OD₆₀₀) on a spectrophotomer. OD₆₀₀ values of cultures containing inhibitors were then normalized to DMSO controls. Three replicates were conducted with each inhibitor and growth was compared to controls (set at 1) using a one-sample t-test.

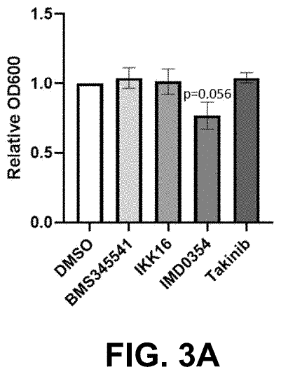

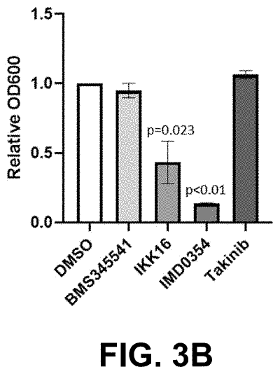

The purpose of this example was to determine whether the NF-kB signaling inhibitors had any direct effects on an entomopathogenic bacteria of interest, which could confound the interpretation of in vivo experiments. The results are shown in FIG. 3A and FIG. 3B. FIG. 3A shows the direct effects of NF-kB signaling inhibitors on P. entomophila and FIG. 3B shows the direct effects of NF-kB signaling inhibitors on B. thuringiensis israelensis. The results in FIG. 3A and 3B demonstrate that IMD0354 inhibited the growth of both P. entomophila (t-test, p=0.056) and B. thuringiensis israelensis (t-test, p<0.01), and IKK16 inhibited the growth of B. thuringiensis israelensis (t-test, p=0.024). The results further demonstrate that BMS345541, IKK16, and Takinib did not affect the growth of P. entomophila, and BMS345541 and Takinib did not affect the growth of B. thuringiensis israelensis. These results demonstrate that the NF-kB signaling inhibitors may still be utilized in combination with entomopathogenic bacteria, however, with the understanding that some inhibitors may slightly reduce the quantity of certain entomopathogenic bacteria being administered.

### EXAMPLE 3

### Combination Treatments with NF-kB Signaling Inhibitors and Bacterial Entomopathogens and Effects on Resistance

The effect of the combination treatment of NF-kB signaling inhibitors and bacterial entomopathogens on bed bug resistance to the bacterial entomopathogens was analyzed. To determine if NF-kB signaling inhibitors could reduce resistance to orally provisioned entomopathogenic bacteria, cultures of each bacterium were grown overnight by shaking at room temperature. The following day, cultures of P. entomophila were standardized to an OD₆₀₀ value of 2.3 (3×10⁸ colony forming units/mL) and cultures of B. thuringiensis isralensis were standardized to an OD₆₀₀ value of 2.2 (7×10⁷ colony forming units/mL), based on their overnight growth across replicates. P. entomophila was then further diluted 1:100 in defibrinated rabbit blood, whereas B. thuringiensis israelensis was further diluted 1:50 in defibrinated rabbit blood due to its generally lower virulence. The evaluated inhibitors or DMSO diluent were added to the blood meal containing diluted bacteria to a final concentration of 10 ug/mL. The groups of bed bugs fed DMSO diluent in blood were included as controls. Groups of bed bugs consisting of roughly even numbers of adult male and female bed bugs that had not blood fed for at least seven days were provided access to treated blood meals using the artificial membrane system (Hemotek Ltd.) until fully engorged. Short-term mortality was then monitored over a period of three days. Three independent biological replicates with 10-14 insects per group were carried out and cumulative survival curves were compared using the Gehan-Breslow-Wilcoxon test.

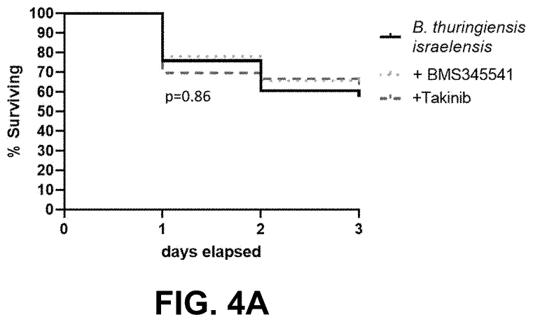

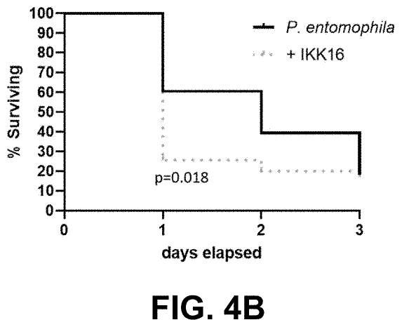

The results are shown in FIG. 4A and FIG. 4B. FIG. 4A shows the three-day survivorship of bed bugs fed combinations of NF-KB signaling inhibitors and B. thuringiensis israelensis, and FIG. 4B shows the three-day survivorship of bed bugs fed combinations of NF-KB signaling inhibitors and E. entomophila. As shown in the figures, when NF-kB signaling inhibitors were administered together with entomopathogenic bacteria, variable effects were observed. As shown in FIG. 4A, the administration of 10 μg/mL of BMS345541 or Takinib had little to no effect on mortality during infection with B. thuringiensis (FIG. 4A, Gehan-Breslow test, p=0.86). The same inhibitors also had little to no effect on mortality during P. entomophila infection (not shown in the figures). However, when P. entomophila was combined with 10 μg/mL of IKK16, the rate of death was significantly increased relative to insects infected with the bacterium alone (FIG. 4B, Gehan-Breslow test, p=0.018). All three replicates produced consistent patterns and no mortality was observed in blood controls. Mortality at day 1 was 39.4% in the P. entomophila treated group but was increased to 74.3% when combined with IKK16. Similarly, at day 2, mortality in the P. entomophila group was 60.6% but was increased to 80% when combined with IKK16. At day 3, mortality was 81.8% in the P. entomophila group and 82.9% when combined with IKK16.

The results demonstrated that during infection, NF-kB signaling inhibitors can act as synergists of bacterial entomopathogens to enhance the rate of mortality, which is an important parameter in the context of control. Not only did the results demonstrate that P. entomophila has efficacy against bed bugs when used alone, the combination with IKK16 significantly increased bedbug mortality. As IKK16 was shown to not provide any effect on bedbugs as a lone agent, as shown in Example 1, the increased mortality when used in combination with P. entomophila demonstrates the synergistic efficacy achieved by the combination of components. The results further demonstrate the beneficial synergistic effects when combining an NF-kB signaling inhibitor with a gram-negative bacterium.

### EXAMPLE 4

### Estimation of Bacterial Entomopathogen Load in Vivo

The bacterial load of entomopathogen was further analyzed to determine whether enhanced mortality during P. entomophila infection was associated with increased bacterial load (reduced resistance). For this analysis, adult male bed bugs that had not fed for at least seven days were provided access to blood meals containing P. entomophila with or without 10 μg/mL of IKK16 using the artificial membrane system (Hemotek Ltd.) until fully engorged. The two treatments were prepared as described in Example 3. After 24 hours, live and dead bed bugs from each infected treatment group were collected. Individual insects were surface sterilized by rinsing with 10% bleach and 70% ethanol and homogenized in sterile phosphate buffered saline (PBS). Homogenates were then serial diluted in PBS and plated on LB agar plates to estimate the load of P. entomophila bacteria expressed as colony forming units (CFU) per insect after 24 hours of incubation at 28° C. Because culturable bed bug commensals in the gut are minimal and slow growing, this methodology allows for the specific quantification of P. entomophila. Two independent biological replicates were conducted (15 individual insects examined per treatment group in total). The insects in each treatment were further subdivided into dead and live categories for analysis. One outlier value was removed from the live P. entomophila treated group based on the results of ROUT testing. P. entomophila loads were compared using ANOVA with adjustment for multiple comparisons.

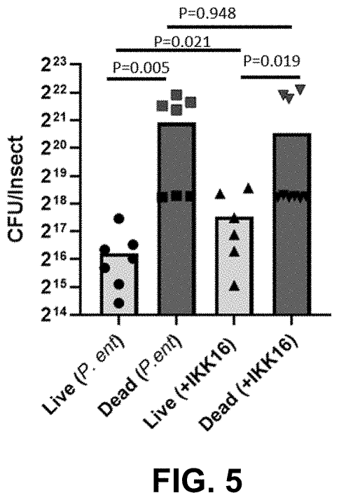

To determine whether mortality during the combination treatment of P. entomophila and IKK16 was associated with the mechanism of reduced resistance (higher bacterial loads) rather than reduced tolerance (death at lower bacterial loads), bacterial loads in insects fed with P. entomophila alone or in combination with IKK16 were compared 24 hours post-infection. The results of P. entomophila load during in vivo infection are shown in FIG. 5.

As shown in FIG. 5, individual data points derived from two independent biological replicates and their mean are provided. Bacterial loads were compared using ANOVA with adjustment for multiple comparisons. The four square data points outside of the bar area for the “Dead (P. ent)” group, and the three inverted triangle data points outside of the bar area for the “Dead (+IKK16)” group, indicate insects suspected of having experienced post-mortem bacterial replication which were excluded from the statistical analysis. By 24 hours post-infection, significantly lower survival was observed in the infected group treated with IKK16 (FIG. 4B). Bed bugs that died from infection by 24 hours post-feeding exhibited a bimodal distribution of bacterial loads. One cluster of dead bed bugs harbored lower CFU levels comparable to the upper threshold seen in live insects, suggesting that these insects had only recently died and were near the BLUM (FIG. 5). Meanwhile, another cluster of dead bed bugs harbored exponentially more P. entomophila CFUs. In these insects, some post-mortem bacterial replication may have occurred, and they were removed from statistical analysis to make a more conservative comparison between live and dead individuals. Whether fed P. entomophila alone (ANOVA, p=0.005) or in combination with IKK16 (ANOVA, p=0.091), dead bed bugs harbored higher P. entomophila loads than those that remained alive. Further, bed bugs treated with IKK16 that remained alive 24 hours-post infection harbored higher loads of P. entomophila than live counterparts not treated with the inhibitor (ANOVA, p=0.021). These data suggest that IKK16 boosts mortality by reducing the innate ability of bed bugs to clear the pathogen (i.e., reduces resistance), since the inhibitor did not demonstrate any effects on bed bugs when given alone (FIG. 2), did not affect P. entomophila growth in vitro (FIG. 3A and 3B), and did not affect tolerance (i.e., produce mortality with lower bacterial loads) in vivo (FIG. 5).

The inventions being thus described, it will be obvious that the same may be varied in many ways. Such variations are not to be regarded as a departure from the spirit and scope of the inventions and all such modifications are intended to be included within the scope of the following claims.

What is claimed is:

1. A treatment composition for controlling bed bugs, comprising:
an NF-kB signaling inhibitor; and
a biological control agent comprising a gram-negative entomopathogenic bacteria,
wherein the combination of the NF-kB signaling inhibitor and the biological control agent reduces bed bug resistance to the biological control agent.

2. The composition of claim 1, wherein the entomopathogenic bacteria is selected from the group consisting of Xenorhabdus nematophila, Serratia entomophila, Serratia marcescens, Photorhabdus luminescens, Pseudomonas aeruginosa, Pseudomonas entomophila, Pseudomonas fluorescens, Rickettsiella popilliae, Rickettsiella chironomi, and Chromobacterium subtsugae.

3. The composition of claim 1, wherein the concentration of entomopathogenic bacteria is present in an amount of between about 1×10³ CFU/mL to about 1×10¹⁰ CFU/mL.

4. The composition of claim 1, wherein the NF-kB signaling inhibitor comprises an IKK inhibitor, a TAK1 inhibitor, an IKB degradation inhibitor, an NF-kB nuclear translocation inhibitor, a p65 acetylation inhibitor, an NF-kB-DNA binding inhibitor, an NF-kB transactivation inhibitor, or a combination thereof.

5. The composition of claim 4, wherein the NF-kB signaling inhibitor comprises IKK16.

6. The composition of claim 1, wherein the NF-kB signaling inhibitor comprises IKK16 and wherein the entomopathogenic bacteria comprises Pseudomonas entomophila.

7. The composition of claim 1, wherein the NF-kB signaling inhibitor is present in a concentration of from about 1 μg/mL to about 50 μg/mL.

8. The composition of claim 1, wherein the composition further comprises a carrier comprising water, dimethyl sulfoxide (DMSO), a ketone, an alcohol, an aldehyde, a polyethylene glycol, or a combination thereof, or wherein the composition further comprises a chemical insecticide or pesticide.

9. A method of reducing bed bug resistance to a biological control agent, comprising:
combining an NF-kB signaling inhibitor with a biological control agent comprising a gram-negative entomopathogenic bacteria;
reducing bed bug resistance to the biological control agent.

10. The method of claim 9, wherein the bed bug mortality is higher with the combination of the NF-kB signaling inhibitor and the biological control agent compared to the bed bug mortality using the biological control agent alone.

11. The method of claim 9, wherein the entomopathogenic bacteria is selected from the group consisting of Xenorhabdus nematophila, Serratia entomophila, Serratia marcescens, Photorhabdus luminescens, Pseudomonas aeruginosa, Pseudomonas entomophila, Pseudomonas fluorescens, Rickettsiella popilliae, Rickettsiella chironomi, and Chromobacterium subtsugae.

12. The method of claim 9, wherein the concentration of entomopathogenic bacteria is present in an amount of between about 1×10³ CFU/mL to about 1×10¹⁰ CFU/mL.

13. The method of claim 9, wherein the NF-kB signaling inhibitor comprises an IKK inhibitor, a TAK1 inhibitor, an IKB degradation inhibitor, an NF-kB nuclear translocation inhibitor, a p65 acetylation inhibitor, an NF-kB-DNA binding inhibitor, an NF-kB transactivation inhibitor, or a combination thereof.

14. The method of claim 11, wherein the NF-kB signaling inhibitor comprises IKK16.

15. The method of claim 9, wherein the NF-kB signaling inhibitor comprises IKK16 and wherein the entomopathogenic bacteria comprises Pseudomonas entomophila.

16. The method of claim 9, wherein the NF-kB signaling inhibitor is present in a concentration of from about 1 μg/mL to about 50 μg/mL.

17. A method of controlling bed bugs, comprising:
providing a therapeutically effective amount of a treatment composition comprising an NF-kB signaling inhibitor and a biological control agent comprising a gram-negative entomopathogenic bacteria;
attracting the bed bugs to the treatment composition; and
infecting the bed bugs with the treatment composition,
wherein the combination of the NF-kB signaling inhibitor and the biological control agent reduces bed bug resistance to the biological control agent.

18. The method of claim 17, wherein the treatment composition is provided as a bait or trap ingestible to the bed bugs.

19. The method of claim 17, wherein the treatment composition is provided as an aerosol, a solution, a spray, or a gel, and applied to a substrate surface.

20. The method of claim 19, wherein the substrate surface is a surface of a bed frame, headboard, door or window trim, light switch, baseboard, mattress, carpet, furniture, linen, dust ruffle, and/or bedding.
